(19) United States
(12) Patent Application Publication
(10) Pub. No.: US 2025/0223136 A1
(43) Pub. Date: Jul. 10, 2025

(54) PLATFORM FOR AN ELEVATOR SYSTEM FOR A BUILDING WHICH IS UNDER CONSTRUCTION

(71) Applicant: Inventio AG, Hergiswil (CH)

(72) Inventors: Lukas Christen, Kilchberg (CH); Stefan Weber, Niederwil AG (CH)

(21) Appl. No.: 18/849,560

(22) PCT Filed: Feb. 27, 2023
(86) PCT No.: PCT/EP2023/054800

§ 371 Date: Sep. 23, 2024

(30) Foreign Application Priority Data
Mar. 30, 2022 (EP) 22165585.5

(51) Int. Cl. B66B 11/00; B66B 19/00

(52) U.S. Cl. CPC B66B 11/0005; B66B 19/00

(57) ABSTRACT

A platform for an elevator system in a building that is under construction, the building having an elevator shaft that becomes taller as the building height increases over the course of the building phase of the building, includes a pneumatically activated seal for sealing a gap between platform and the walls of the elevator shaft. The seal is configured as a circumferential seal attached to the platform. A compressed air source in the form of a compressor is arranged on the platform to operate the pneumatically activated seal.

### FIELD

The invention relates to a platform for an elevator system comprising an elevator shaft that becomes taller as the building height increases over the course of the building phase of the building, and such an elevator system. This elevator system can be used in particular on high-rise construction sites.

### BACKGROUND

During the construction of a building, the lower floors created first can be finished to such an extent that they are already habitable or usable for other purposes. For this purpose, the elevator system comprises an elevator car with which the floors already used as residential or business premises can be accessed during the building phase of the building. This so-called construction-phase elevator comprising this elevator car grows with the building, so to speak, i.e., the usable lifting height of the construction elevator grows as the height of the building or elevator shaft increases. This makes it possible for construction workers and building materials or optionally users of apartments or business premises already occupied before the building is finished to be conveyed with the elevator car during the construction period of the building. Such an elevator car is known from US 2016/0152442 A1. The elevator system has a machine platform that can be moved along the elevator shaft and from which the elevator car is suspended via support means arranged in the elevator shaft. The machine platform is raised in order to increase the usable lifting height of the elevator car in the elevator shaft. To lift the machine platform, a platform is provided that can be moved along the elevator shaft to form a support structure, which can be supported on the wall of the elevator shaft. This support structure arranged above the machine platform is raised to a height at which the platform carried by this support structure can be lifted a certain distance by means of a first lifting device installed in the upper region of the elevator shaft before the machine platform is lifted. A second lifting device, which is arranged on the aforementioned support structure, is used to lift the machine platform.

With the aforementioned prior art, the elevator car from the building phase can continue to be used for normal use of the building after completion of the building. However, there are also concepts in which, after the building is completed, the elevator car from the building phase is replaced by a new elevator car. In such a case, the construction-phase elevator car can be configured as a self-propelled elevator car. Such a self-propelled elevator car, which is used in an elevator system for a building which is under construction and which comprises an elevator shaft that becomes taller as the building height increases over the course of the building phase of the building, has become known, for example, from WO 2019/238530 A1. Here, too, different platforms are used.

A problem with elevator systems having increasingly higher elevator shafts is that over the course of the building phase of the buildings, the building-phase elevators can be damaged by falling objects. Also, people located inside the elevator shaft, such as maintenance personnel located on the elevator car, can be injured by falling objects. Also at risk are people who, for example, are on an assembly platform from which the guide rails for guiding the elevator car are assembled. Furthermore, unwanted contamination from concrete can occur, for example when climbing formwork is being used. The construction of elevator shafts in buildings may be done using such climbing formwork. Climbing formwork is among the discontinuous formwork systems and is used to manufacture tower-like structures. It can be used to create concrete portions for the elevator shaft floor by floor.

### SUMMARY

It is an object of the present invention to overcome the disadvantages of the known technology and in particular to provide a platform for an elevator system of the type mentioned at the outset which reliably protects the shaft space below the platform from falling parts and dirt and which is easy to operate. Furthermore, the elevator system equipped with such a platform should be able to be adapted to the increasing height of the building in a simple and efficient manner.

According to the invention, these and other objects are achieved with a platform having the features described below. The fact that the platform comprises a pneumatically activated seal for sealing or closing a gap between platform and elevator shaft which is designed as a circumferential seal attached to the platform allows a number of advantages to be achieved. The aforementioned gap can be reliably sealed. The seal can be precisely controlled thanks to its pneumatic mode of action. If required, the sealing effect can be easily created by appropriate control and, as applicable, canceled for the opposite case (return to a rest position). The platform, which can be moved vertically as the building height increases, can, for example, comprise an O-ring seal, wherein the volume of the O-ring seal is variable depending on the pressure applied to a cavity of the seal. However, other sealing variants are also conceivable. For example, the seal could also be designed as a pneumatic bellows. The circumferential seal forms a preferably closed or endless sealing arrangement with respect to the plan view. The pneumatically activated seal can be used in combination with various types of platforms, which are used per se in the elevator system mentioned at the outset with an elevator shaft that becomes taller as the building's height increases over the course of the building phase of the building. It is also conceivable that platforms of such elevator systems could be retrofitted.

In the present document, the term “elevator shaft” should be understood to mean a space in a building under construction, the height of which increases in accordance with the construction progress, wherein the space is dimensioned and configured such that at least one elevator car of an elevator, usually an elevator car and a counterweight of one elevator each, can move upward and downward along vertical tracks in the space. Such an elevator shaft can be a single shaft enclosed by shaft walls. However, the elevator shaft can also be part of a continuous space, in which part the tracks of the elevator car and, if applicable, the counterweight of one of the at least two elevators arranged parallel to one another are arranged in each case, wherein there is no shaft wall between the tracks of adjacent elevators but usually steel beams for attaching elevator components.

The pneumatically activated seal can be designed in such a way that it can be moved between a rest position, in which the seal is spaced apart from the elevator shaft or the adjacent shaft wall and thus allows trouble-free vertical movement of the platform, and an active position, in which the seal is increased in volume relative to the rest position in such a way that the seal contacts the shaft wall or at least approaches it, so that the gap between platform and elevator shaft is completely or almost completely bridged to close it. The gap can be bridged completely or almost completely. A hermetic sealing of the elevator shaft by the seal is therefore not absolutely necessary; smaller open places are conceivable, so that the protective effect is still sufficient.

The platform may comprises a base component which forms, for example, a protective roof or a support structure, which base component is adapted to the shaft space and almost completely fills it in a plan view. This base component can be configured as a plate or comprise a plate. When the base component is installed or during the building phase, it is preferably oriented horizontally. The aforementioned pneumatically activated seal is attached to the outside or edge of the base component.

The seal can consist of an elastic or stretchable polymeric material, wherein elastomers and particularly preferably rubber are preferred as polymeric materials. The polymeric material can be selected from the group of thermoplastic elastomers, for example olefin-based or urethane-based, cross-linked olefin-based thermoplastic elastomers, thermoplastic copolyesters, styrene block copolymers (SBS, SEBS, SEPS, SEEPS and MBS) and thermoplastic copolyamides. Furthermore, it can contain plasticizer-containing materials, preferably polypropylene, acrylonitrile-butadiene-styrene copolymer, polycarbonate, polyvinyl chloride, polymethyl methacrylate, polyethylene terephthalate, polyurethane and the like, as well as mixtures of these materials.

The pneumatically activated seal can be configured as a hollow chamber seal having at least one cavity, wherein the at least one cavity of the seal is filled or can be filled with air or possibly another gaseous medium and wherein the pressure can be changed by means of a pneumatic actuator in the cavity of the seal to create the desired active position. The wall of the pneumatically activated seal surrounding the cavity can have a wall thickness of about 0.5 to 10 mm and preferably about 2 to 5 mm, whereby the seal can also withstand the high mechanical stresses during the building phase, for example due to abrasion on the shaft wall.

It can be advantageous if the pneumatically activated seal is configured as a hose-like sealing strip.

The platform can have a substantially rectangular basic shape in relation to a plan view or in the vertical view, wherein the platform is rounded in its corner regions so that the seal can be or is applied to the platform even in the corner regions without buckling. This rounding of the platform refers to the plan view of the platform or—if the platform is used in the elevator system—to a vertical viewing direction. Preferably, the rounded corner regions of the platform of the base component may have a radius of at least 5 cm and preferably at least 10 cm. If the platform has a base component that is substantially rectangular in plan view, the corner regions of the base component may be rounded in this way.

For optimum sealing, it is advantageous if edge wedges are attached or integrally formed onto the seal in the corner regions to seal the corner regions of the elevator shaft. The edge wedges each form a kind of corner piece and ensure that the pneumatically activated seal in the active position also fills the corners of the shaft more or less precisely. The edge wedges can be made of the same material as the seal or be made of a different plastics material. The edge wedges can be separate sealing components that are glued or otherwise fixed to the seal. However, the edge wedges can also be formed from the same material and integrated into the seal to form a monolithic component.

Furthermore, the pneumatically activated seal can be reinforced or provided with covers at least in the region of the upper side of the seal, whereby the comparatively sensitive elastic or stretchable polymer material of the seal is protected. For example, the seal can be completely or partially covered with an abrasion-resistant and/or cut-resistant film or other layer for reinforcement.

The seal may be arranged on the front side of the platform. For example, if the platform has a rectangular base component, the seal may be arranged on the end faces of the base component. It is also conceivable to arrange the seal on the top or bottom of the base component.

The platform may have a circumferential groove to accommodate the seal. This groove forms a kind of sealing bed for the seal, so that it is held securely in place.

It is advantageous if the seal is arranged at the bottom of the platform. The platform can comprise a preferably plate-like roof structure for forming a protective roof and for covering the elevator shaft, and the seal can be arranged below or on an underside of the roof structure. This arrangement has the advantage that the seal or at least portions of the seal are protected by the roof structure. The arrangement of the seal can be such that in the rest position it is completely covered by the roof structure and in the active position a front region of the seal projects beyond the roof structure.

A further aspect of the invention relates to an elevator system for a building which is under construction and which comprises an elevator shaft that becomes taller as the building height increases over the course of the building phase of the building, the system comprising the platform described above. The elevator system having at least one platform equipped with the pneumatically activated seal reliably protects the shaft region below from falling parts and dirt. The elevator system may comprise control means for controlling and operating the seal. The control means can be designed in such a way that, after a lifting process in which the platform has been moved, the pneumatically activated seal is automatically moved from the rest position to the active position when the desired vertical position is reached.

The pneumatically activated seal is preferably used in platforms that are used in locations where the guide rail has not yet been installed. For example, the platform equipped with the pneumatically activated seal can be an upper protection platform that forms a protective roof for the assembly platform below.

The pneumatically activated seal can also be used for platforms where the guide rails are already assembled. For example, the pneumatically activated seal could be used in a protective roof of the machine platform, as shown in WO 2015/003964 A1 in FIG. 4. It is also conceivable that the seal is divided into segments and that gaps are provided in the region of the rails. Alternatively, it is also conceivable to adapt the shape of the platform and seal, e.g., by means of U-shaped indentations, so that the rail is bypassed and the gap relative to the rail is reduced in the active position.

Finally, a further aspect of the invention relates to a method for constructing an elevator system for a building which is under construction and which comprises an elevator shaft that becomes taller as the building height increases over the course of the building phase of the building, wherein a usable lifting height of the elevator system is adapted to an increasing height of the building by carrying out at least one lifting process, in which lifting process, for example, a machine platform having an elevator drive and an elevator car suspended from the machine platform via support means are lifted in the elevator shaft by means of a lifting device. The method comprises the use of a platform equipped with a pneumatically activated seal. The seal is activated during the building phase; in the corresponding active position, the seal seals or closes a gap between platform and elevator shaft. For a lifting operation, the seal is brought into the rest position, in which the seal is spaced apart from the elevator shaft, allowing the platform to be moved upward without interference. After the lifting process, the seal is returned to the active position to continue the building phase.

### DESCRIPTION OF THE DRAWINGS

Additional advantages and individual features of the invention are derived from the following description of an exemplary embodiment and from the drawings. In the drawings:

FIG. 1 is a schematic representation of an elevator system for a building which is under construction having an elevator shaft that becomes taller as the building height increases over the course of the building phase of the building,

FIG. 2 is a side view of protection platform of an elevator system according to FIG. 1,

FIG. 3a is a highly simplified side view of a platform having a pneumatically activated seal in a rest position,

FIG. 3b shows the platform with the pneumatically activated seal in an active position,

FIG. 4a shows the platform from FIG. 3a in plan view (rest position),

FIG. 4b shows the platform from FIG. 3b in plan view (active position),

FIG. 5a is an enlarged detailed view of a corner region of a platform with an alternative pneumatically activated seal in the rest position, and

FIG. 5b shows the corner region and the platform with the seal in the active position.

### DETAILED DESCRIPTION

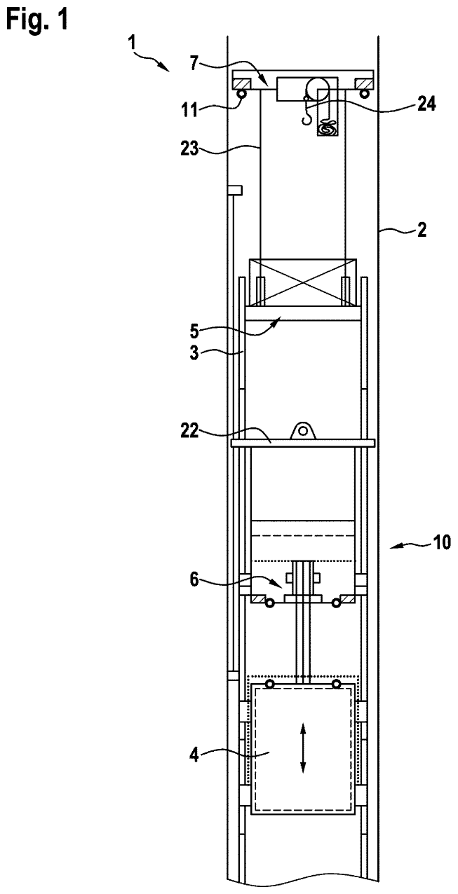

FIG. 1 schematically shows an elevator system 1 for a building 10 which is under construction. The building 10 comprises an elevator shaft 2 that becomes taller as the building height increases over the course of the building phase. An elevator car 4 is installed in the elevator shaft 2. During vertical movement, the elevator car 4 is guided on at least one guide rail portion 3. Above the elevator car 4, the elevator system 1 has an arrangement for equipping the upward-growing elevator shaft 2 in particular with guide rails for the guide rail portion 3. This arrangement comprises a protection platform 7, a machine platform 6 and an assembly platform 5 arranged between these two platforms 6, 7. The assembly platform 5 is the platform from which the guide rail portion 3 is extended upward. The assembly platform 5 serves as a working platform for assembly personnel. Furthermore, the assembly platform 5 can also be used as transport means for other elevator components to be assembled in addition to the guide rails.

For the sake of simplicity, only one guide rail portion 3 is shown in FIG. 1. Two guide rail portions lying opposite one another are preferably used to guide the elevator car 4. The elevator last mentioned usually comprises not only the elevator car but also a counterweight (not shown here). Multiple guide rail portions are necessary for the optimal linear guidance of the elevator car and the counterweight, wherein each guide rail portion consists of guide rail profile parts arranged in a row.

Except for the region of the elevator shaft 2 extending over a plurality of floors, other parts of the building outside the elevator shaft 2 are not shown in FIG. 1. The special feature of the elevator shaft 2 is the vertical extension which in the case of certain elevator shafts can practically extend over the entire height of the building. The building 10 can comprise one or more such elevator shafts 2. The elevator shaft 2 is designed in the present exemplary embodiment for one elevator having an elevator car and a counterweight. However, the elevator shaft 2 can also be designed for multiple elevators. The elevator shaft 2 could also be designed for a self-propelled construction-phase elevator car.

The elevator car 4 allows the transport of persons and goods to and from the lower floors even during the building phase of the building. In particular, the elevator car can be used to transport construction workers and building materials. However, users of apartments or business premises already occupied before the building is finished can also be conveyed between at least the floors associated with these spaces in compliance with the regulations.

Viewed in the vertical direction, the elevator shaft 2 is divided into a plurality of portions, so to speak. In a second portion of the elevator shaft 2, which is located below the machine platform 6, the elevator shaft 2 is already installed with the necessary guide rails for the linear guidance of the elevator car 4 and the counterweight of the elevator for the finished building. In this portion, the elevator system 1 for the building 2 which is under construction has a conventional elevator car 4 and a counterweight (not shown) that can move in the opposite direction. The elevator car 4 presented here could also be replaced by a self-propelled construction-phase elevator car 4 for the transport of persons or goods for the duration of the building phase of the building 10. In this case, the machine platform 6 could be replaced by another platform and in particular a platform without a drive machine for the elevator.

In a rail assembly phase, at least one guide rail strand 3 is extended upward from the assembly platform 6. This rail assembly phase is shown in FIG. 1. In addition to the assembly of guide rails, further work for the assembly of the shaft equipment or other work steps can be carried out from the assembly platform 5. In the phase referred to simply as the rail assembly phase, the assembly platform 5 can be moved up or down in a vertical direction to the desired position via ropes. The assembly platform 5 is suspended from the protection platform 7 via the cable-based lifting device 23.

The protection platform designated by 7 is temporarily fixed in an upper region of the currently existing elevator shaft 2. The protection platform 7 is designed as a support structure. The support structure serves, inter alia, to support the lifting device 23, with which the assembly platform 5 can be moved upward and downward. The protection platform 7 further comprises means 24 for lifting the machine platform 6. However, the protection platform 7 also has the task of protecting persons and equipment in the elevator shaft 2—in particular in the aforementioned assembly platform 5—from objects that could fall down during the construction work taking place on the building 2.

A growth phase can follow the rail assembly phase. After completion of the rail assembly phase and after the elevator shaft 2 has become sufficiently taller as the construction of the building 10 progresses, the protection platform 7 must be positioned to a next higher level. For example, the protection platform 7 is raised to a next higher level with a construction crane so that, as the building height increases, the upper protection platform can grow with the elevator shaft 2 that has become taller. Under certain circumstances, however, it is also possible to bring the upper protection platform 7 to a next higher level by other means and without the use of a crane. After reaching the next higher level, the protection platform 7 is again temporarily fixed in the elevator shaft 2. Thereafter, the machine platform 6 can be raised to a next higher level. For this purpose, the protection platform 7 has lifting means 24, for example a chain hoist. The chain hoist is adapted so that the machine platform 6, preferably together with the attached elevator car 4, can be moved upward for a lifting operation. However, the movement of the machine platform 6 to the upper operating position could also be carried out by means of other lifting equipment, such as by crane, winch, hydraulic hoist or strand jacks. Other elevator systems for a building which is under construction and which comprises an elevator shaft that becomes taller as the building height increases over the course of the building phase of the building are also known which use additional or alternatively designed platforms. The special solution for sealing the shaft space shown below using the example of platform 7 and described in detail can basically be used for all types of platforms that are used in such elevator systems.

The platform 7 of the elevator system 1 according to FIG. 1 can also be assigned to a climbing formwork or even be a component of a climbing formwork. The climbing formwork includes formwork (not shown) for concreting. In this case, the platform 7 can thus be configured as a climbing formwork platform for the story-by-story production of concreting portions of the building core comprising the elevator shaft 2. The climbing formwork platform may comprise integrated climbing drives and be configured as a self-propelled climbing formwork platform. However, as shown in FIG. 1, in another variant the climbing formwork platform 22 can be suspended floor by floor in anchors in the shaft walls 2.

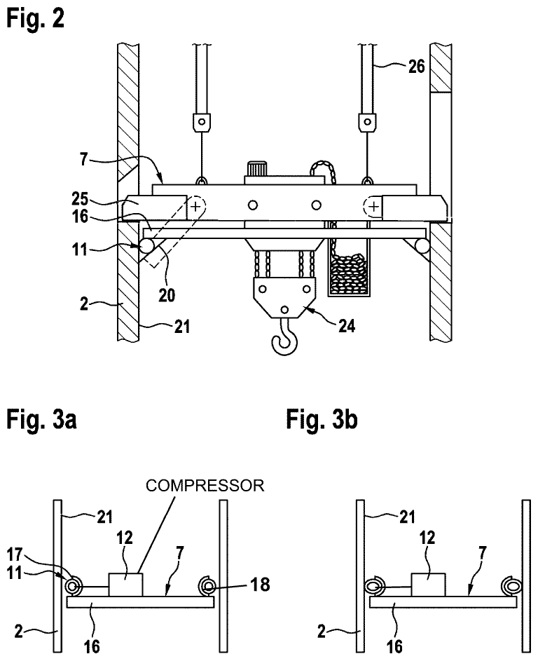

FIG. 2 shows a possible structural design of a protection platform 7, which can be used in elevator systems according to FIG. 1. The protection platform 7 has, for example, pivotable support elements 25 which are inserted into recesses in the shaft walls 2 to secure the protection platform 7. Also visible is the motorized lifting device 24 comprising the chain hoist. The chain of the chain hoist is stored in a chain storage unit. The chain hoist can be used to move the movable machine platform and the elevator car from a lower temporary operating position to the next higher operating position. 26 designates chain hoists by means of which the protection platform 7 can be moved upward.

The protection platform 7 has a plate-like roof structure 16 for covering the elevator shaft 2, on the underside of which structure a seal designated 11 is arranged. The seal 11 is a pneumatically activated seal for sealing or closing the gap between platform 7 and elevator shaft 2. The circumferentially configured seal is attached to the edge of platform 7. In the active position when the pneumatically activated seal 11 is pressurized with compressed air, it presses against the shaft wall surface 21 and thus ensures the desired sealing effect. The seal 11 is configured as a hollow chamber seal and consists, for example, of rubber. Instead of a rubber seal, other elastic or stretchable polymer materials can also be used for the seal. The pneumatically activated seal 11 can, for example, be an O-ring seal the volume of which is variable depending on the pressure applied. The seal 11 is covered at the bottom by a protective plate 20.

The mode of operation of the pneumatically activated seal 11 of the protection platform or another platform for an elevator system for a building which is under construction is shown in FIGS. 3a and 3b. In the rest position shown in FIG. 3a, the pneumatically activated seal 11 is spaced apart from the adjacent shaft wall 21, thereby allowing trouble-free vertical movement of the platform. For example, the shaft space must be secured for the rail assembly phase. For this purpose, the seal 11 is brought into the active position shown in FIG. 3b by supplying compressed air to the seal from a compressed air source or compressor 12 mounted on the platform 7. In the active position, the inflated seal 11 is enlarged in volume compared to the rest position, so that it contacts the shaft wall to close the gap between platform 7 and elevator shaft 2. The pneumatically activated seal 11 is arranged in a seal carrier 17, which is attached here, for example, to the upper side of the roof structure 16 of the platform 7. The seal carrier 17 has a groove 18 for forming a seal bed. However, the seal 11 could also be inserted into other receptacles for the seal, in particular into a circumferential groove with a cross-sectional shape other than the exemplary round one.

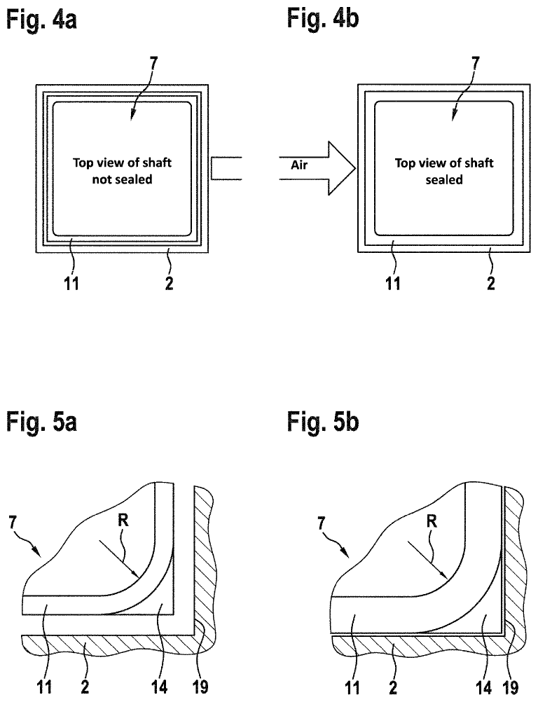

The fact that the pneumatically activated or, in other words, inflatable seal 11 is configured as a circumferential seal which is attached to the platform 7 can also be seen from FIG. 4a. In FIGS. 4a and 4b, which depict the plan view, it can also be seen that the seal 11 is configured to be more or less angular in the corner regions. To form such corners, edge wedges 14 are integrally formed on the seal 11. In the exemplary embodiment according to FIGS. 5a and 5b, the edge wedges 14 are configured as separate elements which are glued to the seal 11 or fixed in another way. The edge wedges 14 ensure that when the seal 11 is activated (active position, FIG. 4b), also no dirt or objects can get down into the corner regions. The edge wedges 14 thus serve to seal the corner regions 19 of the elevator shaft 2.

The platform 7 has a substantially rectangular basic shape in plan view. In its corner regions, the platform 7, or more precisely the roof structure 16, is rounded in plan view or in the vertical direction. The relevant rounded corner regions of platform 7 are characterized by a radius R of at least 5 cm and preferably at least 10 cm. The rounding of the corner regions is to be provided in particular in those regions of the platform with which the seal 11 is in an operative connection. Regions of the platform outside an effective surface for the seal 11, which effective surface is defined, for example, by the groove 18 (cf. FIG. 3a/3b), can still remain as more or less sharp-edged corner regions without rounding.

In accordance with the provisions of the patent statutes, the present invention has been described in what is considered to represent its preferred embodiment. However, it should be noted that the invention can be practiced otherwise than as specifically illustrated and described without departing from its spirit or scope.

1-9. (canceled)

10. A platform for an elevator system in a building, the building being under construction and including an elevator shaft that becomes taller as a height of the building increases over a course of a building phase of the building, the platform comprising:
a pneumatically activated seal adapted to seal or close a gap between the platform and walls of the elevator shaft when the platform is installed in the elevator shaft and the seal is in an active position; and
wherein the seal is a circumferential seal attached to the platform.

11. The platform according to claim 10 including a compressed air source arranged at the platform and connected to operate the seal between a rest position and the active position.

12. The platform according to claim 10 wherein the seal has rounded corner regions.

13. The platform according to claim 12 wherein the corner regions of the seal have a radius of at least 5 cm.

14. The platform according to claim 12 wherein the corner regions of the seal have a radius of at least 10 cm.

15. The platform according to claim 12 including edge wedges attached to or integrally formed onto the seal in the corner regions.

16. The platform according to claim 10 wherein the platform has a circumferential groove formed thereon accommodating the seal.

17. The platform according to claim 10 wherein the seal is arranged on an underside or an upper side of the platform.

18. An elevator system for a building that is under construction, the building having an elevator shaft that becomes taller as a height of the building increases over a course of a building phase of the building, the system comprising:
a platform according to claim 10; and
when the platform is installed in the elevator shaft and the seal is activated, the seal seals or closes a gap between the platform and walls of the elevator shaft.

19. A method for constructing an elevator system for a building, the building being under construction and including an elevator shaft that becomes taller as a height of the building increases over a course of a building phase of the building, the method comprising the steps of:
installing a platform according to claim 10 in the elevator shaft with the seal in the rest position;
activating the seal from the rest position into the active position during the building phase to seal or close a gap between the platform and walls of the elevator shaft;
returning the seal to the rest position for lifting the platform in the elevator shaft during which lifting the seal is spaced apart from the walls of the elevator shaft; and
returning the seal to the active position after the lifting of the platform is complete.

20. A platform for an elevator system in a building, the building being under construction and including an elevator shaft that becomes taller as a height of the building increases over a course of a building phase of the building, the platform comprising:
a pneumatically activated seal adapted to seal or close a gap between the platform and walls of the elevator shaft when the platform is installed in the elevator shaft and the seal is in an active position;
wherein the seal is a circumferential seal attached to the platform;
wherein the seal has rounded corner regions and including edge wedges attached to or integrally formed onto the seal in the corner regions; and
a compressed air source arranged at the platform and connected to operate the seal between a rest position and the active position.

21. The platform according to claim 20 wherein the seal is arranged on an upper side of the platform and the platform has a circumferential groove formed thereon accommodating the seal.

22. The platform according to claim 20 wherein the seal is arranged on an underside of the platform.
